(19) United States
(12) Patent Application Publication
(10) Pub. No.: US 2025/0260126 A1
(43) Pub. Date: Aug. 14, 2025

(54) SOLID ELECTROLYTE FREE STANDING MEMBRANE AND METHOD FOR PREPARING THE SAME

(71) Applicants: Hyundai Motor Company, Seoul (KR); Kia Corporation, Seoul (KR)

(72) Inventors: Kyung Yup Song, Seoul (KR); Ye Seul Park, Seoul (KR); Byung Yong Lee, Seoul (KR)

(21) Appl. No.: 18/883,824

(22) Filed: Sep. 12, 2024

(30) Foreign Application Priority Data
Feb. 14, 2024 (KR) 10-2024-0021203

(51) Int. Cl. H01M 50/44; H01M 10/0525; H01M 10/0562; H01M 50/403; H01M 50/494; H01M 50/497

(52) U.S. Cl. CPC H01M 50/44; H01M 10/0562; H01M 50/403; H01M 50/494; H01M 50/497; H01M 10/0525

(57) ABSTRACT

A method for preparing a solid electrolyte free standing membrane involves mixing sulfide-based solid electrolyte powder with fibrillizable polymer powder to produce a mixture, applying shear stress to fibrillize the polymer, and rolling the mixture to form the membrane. The process parameters include performing the shear stress application for 3 to 25 minutes at 20° C. to 125° C., and rolling for 3 to 25 minutes at 38° C. to 125° C. The mixture contains 0.06% to 0.6% fibrillizable polymer by weight. Specific variations include using polymer powders with average diameters from 1 μm to 1,000 μm, performing the mixing step without solvent, and selecting polymer types such as PTFE. Additionally, the method details the conditions for shear stress application and rolling, as well as the resultant polymer diameters and mixture consistency. The resulting solid electrolyte free standing membrane, comprising sulfide-based solid electrolyte and fibrillized polymer, demonstrates tensile strengths of at least 0.2 MPa and lithium ion conductivity of at least 3 mS/cm. This membrane is particularly suitable for use in all-solid-state batteries.

### CROSS-REFERENCE TO RELATED APPLICATION

This application claims, under 35 U.S.C. § 119(a), the benefit of Korean Patent Application No. 10-2024-0021203, filed in the Korean Intellectual Property Office on Feb. 14, 2024, the entire contents of which are incorporated herein by reference.

### TECHNICAL FIELD

The present disclosure relates to a method for preparing a solid electrolyte free standing membrane and the resulting membrane. Specifically, the disclosure pertains to the field of solid-state batteries, focusing on the formulation and manufacturing of high-performance solid electrolyte membranes. These membranes are used in various electrochemical devices, including but not limited to all-solid-state lithium-ion batteries, to improve mechanical properties and ionic conductivity. The disclosure also covers aspects of materials science, particularly the use of sulfide-based solid electrolytes and fibrillizable polymers to achieve enhanced battery performance.

### BACKGROUND

A lithium secondary battery has been developed as a small power source for a smartphone, a small electronic device, and the like, and a demand therefor is increasing with a development of an electric vehicle.

The lithium secondary battery is composed of anode and cathode materials that may transmit and receive lithium ions with each other and an electrolyte that is responsible for transporting the lithium ions. The typical lithium secondary battery uses a liquid electrolyte in which lithium salt is dissolved in an organic solvent, and includes a separator made of an organic fiber that prevents physical contact between the anode and the cathode to prevent short circuit. Because the flammable organic solvent is used as the electrolyte solvent, there is a high possibility of fire or explosion in the event of the short circuit caused by physical damage, and in fact, many accidents have occurred.

An all-solid-state battery replaces the flammable liquid electrolyte with an inorganic solid electrolyte. Oxide and sulfide-based solid electrolytes are mainly used as the inorganic solid electrolytes. Among those, the sulfide-based solid electrolyte is promising because lithium ion conductivity thereof is high enough to be close to that of the liquid electrolyte.

However, the sulfide-based solid electrolyte has poor mechanical properties, resulting in poor processability and battery stability. Further, the sulfide-based solid electrolyte is prone to breaking when a pressure is applied thereto, making mass production difficult. Currently, the sulfide-based solid electrolyte is being used in a pellet form by applying a pressure to solid electrolyte in a powder form on a small scale.

Accordingly, as a method for the mass production of the sulfide-based solid electrolyte, a method for coating the sulfide-based solid electrolyte together with the separator used in existing lithium-ion batteries was proposed, but the advantage, the excellent lithium ion conductivity, of the sulfide-based solid electrolyte is offset because a resistance of the separator is added, it is difficult to reduce a thickness of the entire membrane to a certain level or below because a thickness of the separator is not able to be reduced, and a performance of the solid electrolyte is affected because a solvent is used during the coating.

To solve such problem, a method of preparing a free standing membrane containing the sulfide-based solid electrolyte using a binder dissolved in a solvent has been proposed. However, in this case, because chemical stability of the sulfide-based solid electrolyte is not good, the lithium ion conductivity of the sulfide-based solid electrolyte decreases by the solvent.

### SUMMARY

The present disclosure has been made to solve the above-mentioned problems occurring in the preexisting technologies while advantages achieved by the preexisting technologies are maintained intact.

An aspect of the present disclosure provides a method for preparing solid electrolyte with improved ion conductivity by minimizing a binder content.

In some embodiments, a method for preparing a solid electrolyte free standing membrane involves mixing sulfide-based solid electrolyte powder with fibrillizable polymer powder to produce a mixture, applying shear stress to the mixture to fibrillize the fibrillizable polymer powder, and rolling the resulting mixture to obtain the solid electrolyte free standing membrane. The shear stress application step is performed for about 3 minutes to about 25 minutes under a temperature range from about 20° C. to about 125° C. The rolling step is performed for about 3 minutes to about 25 minutes under a temperature range from about 38° C. to about 125° C. The mixture comprises the fibrillizable polymer powder in an amount from about 0.06% by weight to about 0.6% by weight, based on the total weight of the mixture.

The fibrillizable polymer powder may have an average diameter (D50) from about 1 μm to about 1,000 μm. The mixing step may be performed without the use of a solvent. The rolling step may be performed at a temperature range from about 50° C. to about 100° C. The rolling step may be performed for about 5 minutes to about 20 minutes. The fibrillizable polymer powder may comprise polytetrafluoroethylene (PTFE). An average diameter (D50) of the sulfide-based solid electrolyte may be from about 0.35 μm to about 4 μm. The sulfide-based solid electrolyte powder may be selected from the group consisting of Li2S—P2S5, Li6PS5Cl0.5Br0.5, Li2S—P2S5-LiI, Li2S—P2S5-LiCl, Li2S—P2S5-LiBr, Li2S—P2S5-Li₂O, Li2S—P2S5-Li₂O—LiI, Li2S—SiS2, Li2S—SiS2-LiI, Li2S—SiS2-LiBr, Li2S—SiS2-LiCl, Li2S—SiS2-B2S3-LiI, Li2S—SiS2-P2S5-LiI, Li2S—B2S3, Li2S—P2S5-ZmSn (where m and n are positive numbers and Z is one of Ge, Zn, and Ga), Li2S—GeS2, Li2S—SiS2-Li3PO4, Li2S—SiS2-LixMOy (where x and y are positive numbers and M is one of P, Si, Ge, B, Al, Ga, and In), and Li10GeP2S12 or combinations thereof. The diameter of the fibrillized polymer produced in the shear stress application step may be from about 0.01 μm to about 10 μm. The shear stress application step may be performed at a temperature range from about 25° C. to about 100° C. The rolling step may be performed using a rolling apparatus. The mixture may be transformed into a clay-like consistency after the shear stress application step.

In some embodiments, a solid electrolyte freestanding membrane comprises a sulfide-based solid electrolyte and fibrillized polymer, wherein the fibrillized polymer is present in an amount from about 0.1% by weight to about 0.5% by weight, based on the total weight of the solid electrolyte free standing membrane. The solid electrolyte free standing membrane may have a tensile strength equal to or greater than about 0.2 MPa. The lithium ion conductivity of the membrane may be equal to or greater than about 3 mS/cm. The sulfide-based solid electrolyte may be present in an amount from about 99.4% by weight to about 99.9% by weight, based on the total weight of the solid electrolyte free standing membrane. The fibrillized polymer may have a diameter from about 0.01 μm to about 10 μm. The solid electrolyte free standing membrane may have a thickness of about 100 μm. The sulfide-based solid electrolyte may be selected from the group consisting of Li2S—P2S5, Li6PS5Cl0.5Br0.5, Li2S—P2S5-LiI, Li2S—P2S5-LiCl, Li2S—P2S5-LiBr, Li2S—P2S5-Li₂O, Li2S—P2S5-Li₂O—LiI, Li2S—SiS2, Li2S—SiS2-LiI, Li2S—SiS2-LiBr, Li2S—SiS2-LiCl, Li2S—SiS2-B2S3-LiI, Li2S—SiS2-P2S5-LiI, Li2S—B2S3, Li2S—P2S5-ZmSn (where m and n are positive numbers and Z is one of Ge, Zn, and Ga), Li2S—GeS2, Li2S—SiS2-Li3PO4, Li2S—SiS2-LixMOy (where x and y are positive numbers and M is one of P, Si, Ge, B, Al, Ga, and In), and Li10GeP2S12 or combinations thereof. An all-solid-state battery may comprise the solid electrolyte free standing membrane.

### DETAILED DESCRIPTION

Hereinafter, the present disclosure will be described in more detail to assist in understanding the present disclosure. In this regards, terms or words used herein and claims should not be construed as limited to usual or dictionary meanings thereof, and should be interpreted with meanings and concepts consistent with the technical idea of the present disclosure based on a principle that the inventor is able to appropriately define concepts of the terms to describe his or her invention in the best way.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In the present disclosure, a term ‘average particle diameter (D₅₀)’ refers to a particle diameter at a 50% point of cumulative volume distribution based on the particle diameter. The average particle diameter D₅₀ may be measured by dispersing powder-to-be-measured in a dispersion medium, then introducing the result into a commercially available laser diffraction particle size measuring apparatus (e.g., Microtrac's S3500) to measure a difference in diffraction patterns depending on a particle size when particles pass through a laser beam to calculate particle size distribution, and then calculating the particle diameter at the point that is 50% of the cumulative volume distribution based on the diameter in the measuring apparatus.

### <Method for Preparing Solid Electrolyte Free Standing Membrane>

The present disclosure provides a method for preparing a solid electrolyte free standing membrane.

The method for preparing the solid electrolyte free standing membrane of the present disclosure includes mixing sulfide-based solid electrolyte powder with fibrillizable polymer powder (S1); applying a shear stress to the result of the step S1 to fibrillize the fibrillizable polymer powder (S2); and rolling the result of the step S2 to obtain the solid electrolyte free standing membrane (S3), wherein the step S3 is performed for 3 minutes or more and 25 minutes or less under a temperature condition equal to or higher than 38° C. and equal to or lower than 125° C., and the result of the step S1 contains the polymer powder in an amount equal to or greater than 0.06% by weight and equal to or smaller than 0.6% by weight.

In general, it is known that as the content of the polymer powder that may be fibrillized in the prepared solid electrolyte free standing membrane decreases, ion conductivity improves, but mechanical properties such as tensile strength decrease. The inventors of the present disclosure discovered a preparing method that may greatly improve not only the ion conductivity but also the tensile strength of the prepared solid electrolyte free standing membrane even when the content of the fibrillizable polymer powder is minimized, and completed the present disclosure.

Hereinafter, each step of the method for preparing the solid electrolyte free standing membrane according to an embodiment of the present disclosure will be described.

### 1. Step S1

The method for preparing the solid electrolyte free standing membrane according to an embodiment of the present disclosure may include the mixing of the sulfide-based solid electrolyte powder with the fibrillizable polymer powder (S1).

According to an embodiment of the present disclosure, sulfide-based solid electrolyte that makes up the sulfide-based solid electrolyte powder may be any one of Li₂S—P₂S₅, Li₆PS₅Cl_{0.5}Br_{0.5}, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers and Z is one of Ge, Zn, and Ga), Li₂S—GeS₂, Li₂S—SiS₂—Li₃PO₄, Li₂S—SiS₂—LiₓMO_{y} (where x and y are positive numbers and M is one of P, Si, Ge, B, Al, Ga, and In), and Li₁₀GeP₂S₁₂ or combinations thereof.

According to an embodiment of the present disclosure, an average diameter (D₅₀) of the sulfide-based solid electrolyte powder may be equal to or greater than 0.35 μm and equal to or smaller than 4 μm, as specific examples, may be equal to or greater than 0.4 μm, equal to or greater than 0.45 μm, equal to or greater than 0.5 μm, equal to or greater than 0.55 μm, or equal to or greater than 0.6 μm, and further, may be equal to or smaller than 3.8 μm, equal to or smaller than 3.6 μm, equal to or smaller than 3.4 μm, equal to or smaller than 3.2 μm, and equal to or smaller than 3 μm. When the average diameter of the sulfide-based solid electrolyte powder satisfies the above range, the mechanical properties of the prepared solid electrolyte free standing membrane may be improved.

According to an embodiment of the present disclosure, the sulfide-based solid electrolyte powder may be contained in an amount equal to or greater than 99.4% by weight and equal to or smaller than 99.9% by weight with respect to the result of the step S1, as specific examples, may be contained in an amount equal to or greater than 99.42% by weight, equal to or greater than 99.44% by weight, equal to or greater than 99.46% by weight, equal to or greater than 99.48% by weight, or equal to or greater than 99.5% by weight, and further, may be contained in an amount equal to or smaller than 99.8% by weight, equal to or smaller than 99.7% by weight, equal to or smaller than 99.6% by weight, or equal to or smaller than 99.5% by weight. When the content of the sulfide-based solid electrolyte powder satisfies the above range, the lithium ion conductivity and the tensile strength of the prepared solid electrolyte free standing membrane may be improved. When the content of the sulfide-based solid electrolyte powder exceeds the above-mentioned range, the mechanical properties of the prepared solid electrolyte free standing membrane may not be able to be secured, and when the content of the sulfide-based solid electrolyte powder is smaller than the above-mentioned range, the lithium ion conductivity and the tensile strength may be lowered.

According to an embodiment of the present disclosure, fibrillizable polymer may be any one of butadiene rubber (BR), nitrile butadiene rubber (NBR), hydrogenated nitrile butadiene rubber (HNBR), polyvinylidene difluoride (PVDF), polytetrafluoroethylene (PTFE), and carboxymethylcellulose (CMC), or combinations thereof, and may be PTFE as a specific example.

Polytetrafluoroethylene (PTFE) is a polymer in which all hydrogen elements of polyethylene (PE) are replaced with fluorine elements. Although polytetrafluoroethylene (PTFE) is a polymer with an aliphatic main chain, PTFE has excellent thermal and electrical stability and is widely applied in a field of an electronic material. In particular, PTFE is mainly used in an anode because the polymer has a low highest occupied molecular orbital (HOMO) level and thus has high oxidation stability. Because polytetrafluoroethylene (PTFE) has a cylindrical structure, PTFE may be fibrillized even at a low temperature despite having a high glass transition temperature (Tg).

According to an embodiment of the present disclosure, the average diameter (D₅₀) of the fibrillizable polymer powder may be equal to or greater than 1 μm and equal to or smaller than 1,000 μm. As a specific example, the average diameter (D₅₀) of the fibrillizable polymer powder may be equal to or greater than 10 μm, equal to or greater than 50 μm, equal to or greater than 100 μm, or equal to or greater than 150 μm, and may be equal to or smaller than 900 μm, equal to or smaller than 800 μm, equal to or smaller than 700 μm, or equal to or smaller than 600 μm. When the average diameter of the fibrillizable polymer powder satisfies the above range, the mechanical properties of the prepared solid electrolyte free standing membrane may be improved.

According to an embodiment of the present disclosure, the fibrillizable polymer powder may be contained in an amount equal to or greater than 0.1% by weight and equal to or smaller than 0.6% by weight with respect to the result of the S1 step, as a specific example, may be contained in an amount equal to or greater than 0.15% by weight, equal to or greater than 0.2% by weight, equal to or greater than 0.25% by weight, equal to or greater than 0.3% by weight, equal to or greater than 0.35% by weight, or equal to or greater than 0.4% by weight, and further, may be contained in an amount equal to or smaller than 0.58% by weight, equal to or smaller than 0.56% by weight, equal to or smaller than 0.54% by weight, equal to or smaller than 0.52% by weight, or equal to or smaller than 0.5% by weight. When the content of the fibrillizable polymer powder satisfies the above range, the lithium ion conductivity and the tensile strength of the prepared solid electrolyte free standing membrane may be improved. When the content of the fibrillizable polymer powder exceeds the above range, the lithium ion conductivity and the tensile strength may decrease, and when the content of the fibrillizable polymer powder is smaller than the above range, the mechanical properties of the prepared solid electrolyte free standing membrane may not be able to be secured.

According to an embodiment of the present disclosure, in the step S1, that is, in the mixing of the sulfide-based solid electrolyte powder with the fibrillizable polymer powder, solid-phase mixing may be performed without a separate solvent.

An existing solid electrolyte layer in a form of the free standing membrane is prepared by placing a separator or a non-woven fabric at a center, applying a slurry containing solid electrolyte on one or both surfaces thereof, and drying the slurry. However, viscosity of the slurry must be low so that the solid electrolyte may penetrate into pores of the non-woven fabric, so that processability is very poor. Additionally, during the process of drying the slurry, voids are defined based on the removal of the solvent, thereby deteriorating mechanical and electrochemical properties of the solid electrolyte layer. In addition, not only does the non-woven fabric act as a kind of resistance, but the non-woven fabric also prevents the solid electrolyte from being evenly distributed within the solid electrolyte layer, thereby significantly reducing the lithium ion conductivity.

The present disclosure implements the solid electrolyte free standing membrane containing the sulfide-based solid electrolyte and the fibrillized polymer by applying the shear stress to the mixture containing the sulfide-based solid electrolyte and the fibrillizable polymer powder without the separate solvent to transform the mixture into clay, thereby solving the above problem. Because the fibrillized polymer is entangled with the sulfide-based solid electrolyte and the mechanical properties are improved, the solid electrolyte free standing membrane may maintain a shape thereof. In addition, because a contact between the fibrillized polymer and the sulfide-based solid electrolyte is minimized, the decline in the lithium ion conductivity may be significantly reduced compared to when a binder dissolved in a solvent is used.

In other words, the method for preparing the solid electrolyte free standing membrane according to the present disclosure does not use the solvent to prevent the sulfide-based solid electrolyte from being chemically transformed by the solvent, thereby preventing the lithium ion conductivity from decreasing and preventing problems such as a decrease in an adhesion by a lifting phenomenon of the binder during the solvent removal process.

### 2. Step S2

The method for preparing the solid electrolyte free standing membrane according to an embodiment of the present disclosure may include the applying of the shear stress to the result of the step S1 to fibrillize the fibrillizable polymer powder (S2).

According to an embodiment of the present disclosure, when the shear stress is applied to the mixture containing the sulfide-based solid electrolyte powder and the fibrillizable polymer powder, that is, the result of the step S1, the fibrillizable polymer powder is converted to the fibrillized polymer, thereby producing the result that is transformed into the clay.

According to an embodiment of the present disclosure, the fibrillized polymer may have a diameter equal to or greater than 0.01 μm and equal to or smaller than 10 μm. As a specific example, the fibrillized polymer may have the diameter equal to or greater than 0.02 μm, equal to or greater than 0.04 μm, equal to or greater than 0.06 μm, or equal to or greater than 0.1 μm, and further, may have the diameter equal to or smaller than 8 μm, equal to or smaller than 6 μm, equal to or smaller than 4 μm, and equal to or smaller than 2 μm. The diameter of the fibrillized polymer refers to a diameter of a cross-section of the fibrillized polymer cut in a direction perpendicular to a length direction. When the diameter of the fibrillized polymer is smaller than the above range, the mechanical properties of the solid electrolyte free standing membrane may be insufficient, and when the diameter exceeds the above range, the lithium ion conductivity may decrease.

According to an embodiment of the present disclosure, the shear stress may be applied with an apparatus or a method commonly used in the technical field to which the present disclosure belongs.

According to an embodiment of the present disclosure, the step S2 may be performed at a temperature equal to or higher than 20° C. and equal to or smaller than 125° C. As a specific example, the step S2 may be performed at a temperature equal to or higher than 22° C., equal to or higher than 24° C., or equal to or higher than 25° C., and equal to or lower than 120° C., equal to or lower than 115° C., equal to or lower than 110° C., equal to or lower than 105° C., or equal to or lower than 100° C.°. When the step S2 is performed within the above temperature range, the fibrillizable polymer powder may be easily converted to the fibrillized polymer. Accordingly, even when the content of the fibrillizable polymer powder is equal to or smaller than 0.6% by weight, the prepared solid electrolyte free standing membrane may simultaneously secure the excellent ion conductivity and tensile strength.

According to an embodiment of the present disclosure, the step S2 may be performed for 3 minutes or more and 25 minutes or less. As a specific example, the step S2 may be performed for 3.5 minutes or more, 4 minutes or more, 4.5 minutes or more, or 5 minutes or more, and may be performed for 24 minutes or less, 23 minutes or less, 22 minutes or less, 21 minutes or less, or 20 minutes or less. When the step S2 is performed within the process time range, the fibrillizable polymer powder may be easily converted to the fibrillized polymer. Accordingly, even when the content of fibrillizable polymer powder is equal to or smaller than 0.6% by weight, the prepared solid electrolyte free standing membrane may simultaneously secure the excellent ion conductivity and tensile strength.

### 3. Step S3

The method for preparing the solid electrolyte free standing membrane according to an embodiment of the present disclosure may include the rolling of the result of the step S2 to obtain the solid electrolyte free standing membrane (S3).

According to an embodiment of the present disclosure, in the step S3, that is, in the obtaining of the solid electrolyte free standing membrane, any method of preparing the clay into a thin solid electrolyte membrane by placing a roller on the result prepared in the step S2 and rolling the roller may be applied to the rolling, and the present disclosure may not be limited to any particular method. For example, the rolling may be performed by placing the result prepared in the step S2, that is, the clay and then manually rolling the roller, or may be performed using an instrument such as a rolling apparatus. Specifically, the rolling may be performed by placing the roller on the clay prepared in the step S2 and manually rolling the roller, or may be performed using the instrument such as the rolling apparatus, thereby preparing the clay into the thin solid electrolyte membrane.

In that the rolling is performed directly on the clay, there is a difference from a calendering process in which the clay is pulverized into powder and then the powder is placed between two rolls to prepare the solid electrolyte membrane via rotation of the rolls and a pressure. In other words, the rolling of the step S3 is performed immediately without the result of the step S2 being pulverized, thereby simplifying a process and improving a degree of fibrillization of the fibrillizable polymer powder.

According to an embodiment of the present disclosure, the step S3 may be performed at a temperature equal to or higher than 38° C. and equal to or lower than 125° C. As a specific example, the step S3 may be performed at a temperature equal to or higher than 40° C., equal to or higher than 42° C., equal to or higher than 44° C., equal to or higher than 46° C., equal to or higher than 48° C., or equal to or higher than 50° C., and may be performed at a temperature equal to or lower than 120° C., equal to or lower than 115° C., equal to or lower than 110° C., equal to or lower than 105° C., or equal to or lower than 100° C. When the step S3 is performed within the above temperature range, the solid electrolyte free standing membrane may be easily obtained. Accordingly, even when the content of the fibrillizable polymer powder is equal to or smaller than 0.6% by weight, the prepared solid electrolyte free standing membrane may simultaneously secure the excellent ion conductivity and tensile strength.

According to an embodiment of the present disclosure, the step S3 may be performed for 3 minutes or more and 25 minutes or less. As a specific example, the step S3 may be performed for 3.5 minutes or more, 4 minutes or more, 4.5 minutes or more, or 5 minutes or more, and may be performed for 24 minutes or less, 23 minutes or less, 22 minutes or less, 21 minutes or less, or 20 minutes or less. When the step S3 is performed within the process time range, the fibrillizable polymer powder may be easily converted to the fibrillized polymer. Accordingly, even when the content of the fibrillizable polymer powder is equal to or smaller than 0.6% by weight, the prepared solid electrolyte free standing membrane may simultaneously secure the excellent ion conductivity and tensile strength.

### <Solid Electrolyte Free Standing Membrane>

The present disclosure provides the solid electrolyte free standing membrane prepared with the method for preparing the solid electrolyte free standing membrane described above.

The solid electrolyte free standing membrane according to an embodiment of the present disclosure contains the sulfide-based solid electrolyte; and the fibrillized polymer, wherein the fibrillized polymer is contained in the amount equal to or greater than 0.06% by weight and equal to or smaller than 0.6% by weight.

According to an embodiment of the present disclosure, the sulfide-based solid electrolyte is a composition corresponding to the sulfide-based solid electrolyte powder in the preparing method. The sulfide-based solid electrolyte may be contained in the amount equal to or greater than 99.4% by weight and equal to or smaller than 99.9% by weight with respect to the solid electrolyte free standing membrane, as a specific example, may be contained in the amount equal to or greater than 99.42% by weight, equal to or greater than 99.44% by weight, equal to or greater than 99.46% by weight, equal to or greater than 99.48% by weight, or equal to or greater than 99.5% by weight, and further, may be contained in the amount equal to or smaller than 99.8% by weight, equal to or smaller than 99.7% by weight, equal to or smaller than 99.6% by weight, or equal to or smaller than 99.5% by weight. When the content of the sulfide-based solid electrolyte satisfies the above range, the lithium ion conductivity and the tensile strength of the solid electrolyte free standing membrane may be improved. When the content of the sulfide-based solid electrolyte exceeds the above range, the mechanical properties of the solid electrolyte free standing membrane may not be able to be secured, and when the content is smaller than the above range, the lithium ion conductivity and the tensile strength may be reduced.

According to an embodiment of the present disclosure, the fibrillizable polymer is a composition corresponding to the fibrillizable polymer in the preparing method. The fibrillizable polymer may be contained in the amount equal to or greater than 0.1% by weight and equal to or smaller than 0.6% by weight with respect to the solid electrolyte free standing membrane, as a specific example, may be contained in the amount equal to or greater than 0.15% by weight, equal to or greater than 0.2% by weight, equal to or greater than 0.25% by weight, equal to or greater than 0.3% by weight, equal to or greater than 0.35% by weight, or equal to or greater than 0.4% by weight, and further, may be contained in the amount equal to or smaller than 0.58% by weight, equal to or smaller than 0.56%, equal to or smaller than 0.54% by weight, equal to or smaller than 0.52% by weight, or equal to or smaller than 0.5% by weight. When the content of the fibrillizable polymer satisfies the above range, the lithium ion conductivity and the tensile strength of the solid electrolyte free standing membrane may be improved. When the content of the fibrillizable polymer powder exceeds the above range, the lithium ion conductivity and the tensile strength may decrease, and when the content is smaller than the above range, the mechanical properties of the prepared solid electrolyte free standing membrane may not be able to be secured.

The solid electrolyte free standing membrane according to an embodiment of the present disclosure may secure the excellent tensile strength while satisfying the excellent lithium ion conductivity.

Specifically, the solid electrolyte free standing membrane according to an embodiment of the present disclosure may have the tensile strength measured based on ASTM D638 equal to or greater than 0.2 MPa, and as a specific example, may have the tensile strength equal to or greater than 0.25 MPa, equal to or greater than 0.3 MPa, equal to or greater than 0.35 MPa, or equal to or greater than 0.4 MPa.

In addition, the solid electrolyte free standing membrane according to an embodiment of the present disclosure may have the lithium ion conductivity, which is measured with an amplitude of 10 mV at a room temperature (25° C.) using a PotentioStat (SP-200, Biologics) and with a measurement frequency range from 0.1 Hz to 7 Hz, equal to or greater than 3 mS/cm, and as a specific example, may have the lithium ion conductivity equal to or greater than 3.2 mS/cm, equal to or greater than 3.4 mS/cm, equal to or greater than 3.6 mS/cm, equal to or greater than 3.8 mS/cm, or equal to or greater than 4 mS/cm.

### <All-Solid-State Battery>

The present disclosure provides an all-solid-state battery including the solid electrolyte free standing membrane.

According to an embodiment of the present disclosure, the all-solid-state battery may be a stack of an anode current collector, an anode active material layer, the solid electrolyte free standing membrane, a cathode active material layer, and a cathode current collector. Because a description of the solid electrolyte free standing membrane is the same as the description above, a detailed description thereof will be omitted.

According to an embodiment of the present disclosure, the anode current collector may be an electrically conductive plate-shaped substrate. Specifically, the anode current collector may have a form of a sheet, a thin film, or a foil.

According to an embodiment of the present disclosure, the anode current collector may contain a material that does not react with lithium. Specifically, the anode current collector may contain at least one selected from a group consisting of Ni, Cu, stainless steel (SUS), and combinations thereof.

According to an embodiment of the present disclosure, the anode active material layer may contain an anode active material, a solid electrolyte, a binder, and the like.

According to an embodiment of the present disclosure, the anode active material may not be particularly limited, but may be, for example, a carbon active material or a metal active material.

According to an embodiment of the present disclosure, the carbon active material may be graphite such as mesocarbon microbeads (MCMB) and highly oriented pyrolytic graphite (HOPG), and amorphous carbon such as hard carbon and soft carbon.

According to an embodiment of the present disclosure, the metal active material may be In, Al, Si, and Sn, and an alloy containing at least one of these elements.

According to an embodiment of the present disclosure, the solid electrolyte may be the oxide-based solid electrolyte or the sulfide-based solid electrolyte. It may be desirable to use the sulfide-based solid electrolyte with the high lithium ion conductivity. Because the description of the sulfide-based solid electrolyte has been made above, detailed description thereof will be omitted below.

According to an embodiment of the present disclosure, a conductive material is a composition that forms an electronic conduction path within the electrode. The conductive material may be an sp2 carbon material such as carbon black, conducting graphite, ethylene black, and carbon nanotube, or graphene.

According to an embodiment of the present disclosure, the binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and the like.

According to an embodiment of the present disclosure, the cathode active material layer may contain a cathode active material, a solid electrolyte, a conductive material, a binder, and the like.

According to an embodiment of the present disclosure, the cathode active material may not be particularly limited, but may be, for example, an oxide active material or a sulfide active material.

According to an embodiment of the present disclosure, the oxide active material may be a rock salt layer-type active material such as LiCoO₂, LiMnO₂, LiNiO₂, LiVO₂, and Li₁₊ₓNi_{1/3}Co_{1/3}Mn_{1/3}O₂, a spinel-type active material such as LiMn₂O₄ and Li(Ni_{0.5}Mn_{1.5})O₄, an inverse spinel-type active material such as LiNiVO₄ and LiCoVO₄, an olivine-type active material such as LiFePO₄, LiMnPO₄, LiCoPO₄, and LiNiPO₄, a silicon-containing active material such as Li₂FeSiO₄ and Li₂MnSiO₄, a rock salt layer-type active material in which part of transition metal is replaced with heterometal such as LiNi_{0.8}Co_{(0.2-x)}AlₓO₂ (0<x<0.2), a spinel-type active material in which part of transition metal is replaced with heterometal such as Li₁₊ₓMn_{2-x-y}M_{y}O₄ (M is at least one of Al, Mg, Co, Fe, Ni, and Zn and 0<x+y<2), and lithium titanate such as Li₄Ti₅O₁₂.

According to an embodiment of the present disclosure, the sulfide active material may be copper chevre, iron sulfide, cobalt sulfide, nickel sulfide, and the like.

According to an embodiment of the present disclosure, the solid electrolyte may be the oxide-based solid electrolyte or the sulfide-based solid electrolyte. It may be desirable to use the sulfide-based solid electrolyte with the high lithium ion conductivity.

According to an embodiment of the present disclosure, the conductive material and the binder are the same as described above, so that a detailed description thereof will be omitted.

According to an embodiment of the present disclosure, the cathode current collector may be an electrically conductive plate-shaped substrate. Specifically, the cathode current collector may have a form of a sheet or a thin film.

According to an embodiment of the present disclosure, the cathode current collector may contain at least one selected from a group consisting of indium, copper, magnesium, aluminum, stainless steel, iron, and combinations thereof.

According to an embodiment of the present disclosure, the solid electrolyte free standing membrane is a composition that is located between the anode active material layer and the cathode active material layer and is responsible for movement of lithium ions.

Hereinafter, examples of the present disclosure will be described in detail such that those skilled in the art may easily implement the present disclosure. However, the present disclosure may be implemented in many different forms and may not be limited to examples described herein.

### REFERENCE EXAMPLES, EXAMPLES, AND COMPARATIVE EXAMPLES

### Reference Example 1

99.5 wt % of sulfide-based solid electrolyte Li₆PS₅Cl_{0.5}Br_{0.5} powder with an average diameter of 3 μm and 0.5 wt % of polytetrafluoroethylene powder with an average diameter of 500 μm were mixed with each other in solid phase with a mixer without a separate solvent. Thereafter, the mixture of the sulfide-based solid electrolyte powder and the polytetrafluoroethylene powder was put into a mortar, and then a shear stress was applied at 100° C. for 2 minutes. Therefore, it was identified that the polytetrafluoroethylene powder was fibrillized and the mixture became the clay.

Thereafter, the clay result was placed on a steel plate at a temperature of 100° C. and manually rolled for 3 minutes to prepare a 100 um-thick solid electrolyte free standing membrane.

### Reference Example 2

A solid electrolyte free standing membrane was prepared in the same manner as in Reference Example 1, except that 99 wt % of the sulfide-based solid electrolyte powder and 1 wt % of the polytetrafluoroethylene powder were mixed with each other, then the shear stress was applied for 2 minutes, and then the manual rolling was performed for 3 minutes.

### Reference Example 3

A solid electrolyte free standing membrane was prepared in the same manner as in Reference Example 1, except that 97.5 wt % of the sulfide-based solid electrolyte powder and 2.5 wt % of the polytetrafluoroethylene powder were mixed with each other.

### Example 1

99.5 wt % of the sulfide-based solid electrolyte Li₆PS₅Cl_{0.5}Br_{0.5} powder with the average diameter of 3 μm and 0.5 wt % of the polytetrafluoroethylene powder with the average diameter of 500 μm were mixed with each other in the solid phase using the mixer without the separate solvent. Thereafter, the mixture of the sulfide-based solid electrolyte powder and the polytetrafluoroethylene powder was put into the mortar, and then the shear stress was applied at 100° C. for 5 minutes. Therefore, it was identified that the polytetrafluoroethylene powder was fibrillized and the mixture became the clay.

Thereafter, the clay result was placed on the steel plate at the temperature of 100° C. and manually rolled for 3 minutes to prepare a 100 um-thick solid electrolyte free standing membrane.

### Example 2

A solid electrolyte free standing membrane was prepared in the same manner as in Example 1, except that the clay result was manually rolled for 20 minutes.

### Example 3

A solid electrolyte free standing membrane was prepared in the same manner as in Example 1, except that the shear stress was applied for 20 minutes after the mixture of the sulfide-based solid electrolyte powder and the polytetrafluoroethylene powder was put into the mortar.

### Example 4

A solid electrolyte free standing membrane was prepared in the same manner as in Example 1, except that the clay result was manually rolled at 50° C. for 20 minutes.

### Example 5

A solid electrolyte free standing membrane was prepared in the same manner as in Example 1, except that the shear stress was applied for 5 minutes at 50° C. after the mixture of the sulfide-based solid electrolyte powder and the polytetrafluoroethylene powder was put into the mortar.

### Example 6

A solid electrolyte free standing membrane was prepared in the same manner as in Example 1, except that the shear stress was applied at 25° C. after the mixture of the sulfide-based solid electrolyte powder and the polytetrafluoroethylene powder was put into the mortar.

### Example 7

A solid electrolyte free standing membrane was prepared in the same manner as in Example 1, except that the clay result was manually rolled at 100° C. for 5 minutes.

### Comparative Example 1

99.5 wt % of the sulfide-based solid electrolyte Li₆PS₅Cl_{0.5}Br_{0.5} powder with the average diameter of 3 μm and 0.5 wt % of the polytetrafluoroethylene powder with the average diameter of 500 μm were mixed with each other in the solid phase using the mixer without the separate solvent. Thereafter, the mixture of the sulfide-based solid electrolyte powder and the polytetrafluoroethylene powder was put into the mortar, and then the shear stress was applied at the room temperature (25° C.) for 5 minutes. Therefore, it was identified that the polytetrafluoroethylene powder was fibrillized and the mixture became the clay.

The clay result was calendered to prepare a 100 um-thick solid electrolyte freestanding membrane.

### Comparative Example 2

A solid electrolyte free standing membrane was prepared in the same manner as in Preset Example 1, except that the clay result was manually rolled for 1 minute.

### Comparative Example 3

A solid electrolyte free standing membrane was prepared in the same manner as in Preset Example 1, except that the clay result was manually rolled at a temperature of 25° C. for 10 minutes.

### Comparative Example 4

A solid electrolyte free standing membrane was prepared in the same manner as in Preset Example 1, except that the clay result was manually rolled at a temperature of 150° C. for 10 minutes.

### Comparative Example 5

A solid electrolyte free standing membrane was prepared in the same manner as in Preset Example 1, except that the mixture of the sulfide-based solid electrolyte powder and the polytetrafluoroethylene powder was placed in the mortar and the shear stress was applied for 1 minute.

### Comparative Example 6

A solid electrolyte free standing membrane was prepared in the same manner as in Preset Example 1, except that the mixture of the sulfide-based solid electrolyte powder and the polytetrafluoroethylene powder was placed in the mortar and the shear stress was applied at 150° C.

### Experimental Example

Lithium ion conductivity (mS/cm): For the solid electrolyte free standing membranes prepared in Reference Examples, Examples, and Comparative Examples in a mold with a diameter Φ 13 mm, the ion conductivity was measured with the amplitude of 10 mV at the room temperature (25° C.) using the PotentioStat (SP-200, Biologics) and with the measurement frequency range from 0.1 Hz to 7 Hz, and is described in Tables 1 to 3 below.
Tensile strength (MPa): For the solid electrolyte free standing membranes prepared in Reference Examples, Examples, and Comparative Examples, specimens with a width of 10 mm and a length of 20 mm were obtained. The tensile strength was measured for the specimens under a condition of a cross head speed of 10 mm/min based on ASTM D638, and is described in Tables 1 to 3 below.

TABLE 1

| | Reference Examples | | |
|---|---|---|---|
| | 1 | 2 | 3 |
| PTFE content(wt %) | 0.5 | 1 | 2.5 |
| Shear stress application | 100 | 100 | 100 |
| temperature (° C.) | | | |
| Shear stress application | 2 | 2 | 2 |
| time(minutes) | | | |
| Manual rolling application | 100 | 100 | 100 |
| temperature (° C.) | | | |
| Manual rolling application | 3 | 3 | 3 |
| time (minutes) | | | |
| Lithium ion | 4.01 | 3.43 | 3.38 |
| conductivity(mS/cm) | | | |
| Tensile strength(MPa) | 0.10 | 0.13 | 0.27 |

TABLE 2

| | Examples | | | | | | |
|---|---|---|---|---|---|---|---|
| | 1 | 2 | 3 | 4 | 5 | 6 | 7 |
| PTFE content(wt %) | 0.5 | 0.5 | 0.5 | 0.5 | 0.5 | 0.5 | 0.5 |
| Shear stress application | 100 | 100 | 100 | 100 | 50 | 25 | 100 |
| temperature (° C.) | | | | | | | |
| Shear stress application | 5 | 5 | 20 | 5 | 5 | 5 | 5 |
| time(minutes) | | | | | | | |
| Manual rolling | 100 | 100 | 100 | 50 | 100 | 100 | 100 |
| application | | | | | | | |
| temperature (° C.) | | | | | | | |
| Manual rolling | 10 | 20 | 10 | 10 | 10 | 10 | 5 |
| application | | | | | | | |
| time (minutes) | | | | | | | |
| Lithium ion | 4.06 | 4.01 | 3.87 | 3.85 | 4.01 | 3.89 | 3.96 |
| conductivity(mS/cm) | | | | | | | |
| Tensile strength(MPa) | 0.46 | 0.45 | 0.45 | 0.32 | 0.25 | 0.25 | 0.21 |

TABLE 3

| | Comparative Examples | | | | | |
|---|---|---|---|---|---|---|
| | 1 | 2 | 3 | 4 | 5 | 6 |
| PTFE content(wt %) | 0.5 | 0.5 | 0.5 | 0.5 | 0.5 | 0.5 |
| Shear stress application | 25 | 100 | 100 | 100 | 100 | 150 |
| temperature (° C.) | | | | | | |
| Shear stress application | 5 | 5 | 5 | 5 | 1 | 5 |
| time(minutes) | | | | | | |
| Manual rolling application | — | 100 | 25 | 150 | 100 | 100 |
| temperature (° C.) | | | | | | |
| Manual rolling application | — | 1 | 10 | 10 | 10 | 10 |
| time (minutes) | | | | | | |
| Lithium ion | X | 3.82 | 3.85 | X | 3.95 | X |
| conductivity(mS/cm) | | | | | | |
| Tensile strength(MPa) | X | 0.10 | 0.19 | X | 0.15 | X |

Referring to Table 1 above, it may be seen that as the content of the polytetrafluoroethylene powder decreases, the lithium ion conductivity improves, but the tensile strength decreases.

Referring to Tables 1 and 2 above, in the case of Examples 1 to 7 that satisfy the appropriate shear stress application time/temperature and appropriate manual rolling application time/temperature ranges, it may be seen that, even though the content of the polytetrafluoroethylene powder is relatively low compared to those in Reference Examples 2 and 3, the degree of fibrillization increases, and thus the lithium ion conductivity and the tensile strength are simultaneously improved.

Referring to Tables 2 and 3 above, in the case of Comparative Examples 2 to 6 that do not satisfy the appropriate shear stress application time/temperature and appropriate manual rolling application time/temperature ranges, it may be seen that the lithium ion conductivity and the tensile strength are poor compared to those in Examples 1 to 7 that satisfy the appropriate shear stress application time/temperature and appropriate manual rolling application time/temperature ranges. In particular, in the case of Comparative Example 4 that exceeds the appropriate manual rolling application temperature range and Comparative Example 6 that exceeds the appropriate shear stress application temperature range, defects occurred in the prepared solid electrolyte free standing membranes, and thus the lithium ion conductivity and the tensile strength were not able to be measured.

In addition, in the case of Comparative Example 1 that performs the calendaring instead of the manual rolling, because the content of the polytetrafluoroethylene powder was low and the fibrillization did not proceed sufficiently, the solid electrolyte free standing membrane was not able to be prepared.

The solid electrolyte free standing membrane according to an embodiment of the present disclosure has an excellent ion conductivity and tensile strength.

According to the method for preparing the solid electrolyte free standing membrane according to an embodiment of the present disclosure, the solid electrolyte free standing membrane with the improved ion conductivity and tensile strength may be obtained.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for preparing a solid electrolyte free standing membrane, the method comprising:
(a) mixing sulfide-based solid electrolyte powder with fibrillizable polymer powder to produce a mixture of electrolyte powder and fibrillizable polymer powder;
(b) applying a shear stress to the mixture of step (a) to fibrillize the fibrillizable polymer powder; and
(c) rolling resulting mixture of step (b) to obtain the solid electrolyte free standing membrane,
wherein the step (b) is performed for about 3 minutes to about 25 minutes under a temperature range from about 20° C. to about 125° C.,
wherein the step (c) is performed for about 3 minutes to about 25 minutes under a temperature range from about 38° C. to about 125° C.,
wherein the resulting mixture of step (a) comprises the fibrillizable polymer powder in an amount from about 0.06% by weight to about 0.6% by weight, based on the total weight of the mixture of step (a).

2. The method of claim 1, wherein the fibrillizable polymer powder has an average diameter (D₅₀) from about 1 μm to about 1,000 μm.

3. The method of claim 1, wherein the step (a) is performed without a use of a solvent.

4. The method of claim 1, wherein the step (c) is performed at a temperature range from about 50° C. to about 100° C.

5. The method of claim 1, wherein the step (c) is performed for about 5 minutes to about 20 minutes.

6. The method of claim 1, wherein the fibrillizable polymer powder comprises polytetrafluoroethylene (PTFE).

7. The method of claim 1, wherein an average diameter (D₅₀) of the sulfide-based solid electrolyte is from about 0.35 μm to about 4 μm.

8. The method of claim 1, wherein the sulfide-based solid electrolyte powder is selected from the group consisting of Li₂S—P₂S₅, Li₆PS₅Cl_{0.5}Br_{0.5}, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂2-B₂S₃—LiI, Li₂S—SiS₂—P₂S₅—LiI, Li₂S—B₂S₃, Li₂S—P₂S₅—ZₘSₙ (where m and n are positive numbers and Z is one of Ge, Zn, and Ga), Li₂S—GeS₂, Li₂S—SiS₂—Li₃PO₄, Li₂S—SiS₂-LixMOy (where x and y are positive numbers and M is one of P, Si, Ge, B, Al, Ga, and In), and Li₁₀GeP₂S₁₂ or combinations thereof.

9. The method of claim 1, wherein the diameter of the fibrillized polymer produced in step (b) is from about 0.01 μm to about 10 μm.

10. The method of claim 1, wherein step (b) is performed at a temperature range from about 25° C. to about 100° C.

11. The method of claim 1, wherein the rolling in step (c) is performed using a rolling apparatus.

12. The method of claim 1, wherein the mixture of step (a) is transformed into a clay-like consistency after the shear stress application in step (b).

13. A solid electrolyte free standing membrane comprising:
sulfide-based solid electrolyte; and
fibrillized polymer,
wherein the fibrillized polymer is present in an amount from about 0.1% by weight to about 0.5% by weight, based on the total weight of the solid electrolyte free standing membrane.

14. The solid electrolyte free standing membrane of claim 13, wherein a tensile strength is equal to or greater than about 0.2 MPa.

15. The solid electrolyte free standing membrane of claim 13, wherein a lithium ion conductivity is equal to or greater than about 3 mS/cm.

16. The solid electrolyte free standing membrane of claim 13, wherein the sulfide-based solid electrolyte is present in an amount from about 99.4% by weight to about 99.9% by weight, based on the total weight of the solid electrolyte free standing membrane.

17. The solid electrolyte free standing membrane of claim 13, wherein the fibrillized polymer has a diameter from about 0.01 μm to about 10 μm.

18. The solid electrolyte free standing membrane of claim 13, wherein the solid electrolyte free standing membrane has a thickness of about 100 μm.

19. The solid electrolyte free standing membrane of claim 13, wherein the sulfide-based solid electrolyte is selected from the group consisting of Li₂S—P₂S₅, Li₆PS₅Cl_{0.5}Br_{0.5}, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂2-B₂S₃—LiI, Li₂S—SiS₂—P₂S₅—LiI, Li₂S—B₂S₃, Li₂S—P₂S₅-ZmSn (where m and n are positive numbers and Z is one of Ge, Zn, and Ga), Li₂S—GeS₂, Li₂S—SiS₂—Li₃PO₄, Li₂S—SiS₂-LiₓMO_{y} (where x and y are positive numbers and M is one of P, Si, Ge, B, Al, Ga, and In), and Li₁₀GeP₂S₁₂ or combinations thereof.

20. An all-solid-state battery comprising the solid electrolyte free standing membrane of claim 13.
